(19) United States
(12) Patent Application Publication
(10) Pub. No.: US 2011/0122780 A1
(43) Pub. Date: May 26, 2011

(54) Graceful Wakeup Of Power Saving Communication Apparatuses

(75) Inventors: Johanna M. Nieminen, Espoo (FI); Jarkko Kneckt, Espoo (FI); Narzul A. Mirza, Espoo (FI)

(73) Assignee: Nokia Corporation

(21) Appl. No.: 12/626,038

(22) Filed: Nov. 25, 2009

(51) Int. Cl. H04L 12/26; G08C 17/00

(52) U.S. Cl. 370/252; 370/311

(57) ABSTRACT

An apparatus determines a wireless traffic load; generates at least one timer value based at least in part on the determined traffic load; and initiates a wireless transmission at a time based at least in part on the at least one timer value. The at least one timer value indicates a time for initiating a transmission after changing from a lower power state to a higher power state. In an exemplary embodiment the wireless traffic load is determined via continuous monitoring and initiating the transmission includes obtaining a transmission opportunity for sending a trigger frame or a power save poll frame. Various exemplary techniques are detailed as to how to determine the traffic load. The generated at least one timer value is a maximum time, which may be truncated for example after the apparatus receives a data unit by which to obtain a network allocation vector.

### TECHNICAL FIELD

The exemplary and non-limiting embodiments of this invention relate generally to wireless communication systems, methods, apparatuses and computer programs and, more specifically, relate to changing between a low power or power saving state of an apparatus and a full power or active state of an apparatus.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

The following abbreviations that may be found in the specification and/or the drawing figures are defined as follows:

AIFS arbitration interframe space

AP access point

CCA clear channel assessment

CSMA/CA collision sense multiple access/collision avoidance

EDCA enhanced distributed channel access

GSM global system for mobile communications

LTE long term evolution of UTRAN (E-UTRAN or 3.9G)

MSTA mesh station

MCCA mesh coordinated channel access

MPDU medium access control protocol data unit

NAV network allocation vector

PPDU physical payload data unit

PSM power save mode

STA station (for example a wireless radio)

S-APSD scheduled automatic power save delivery

TBTT target beacon transmission time

TXOP transmission opportunity

U-APSD unscheduled automatic power save delivery

UTRAN universal terrestrial radio access network

WCDMA wideband code division multiple access

WLAN wireless local area network

Portable electronic devices, particularly handheld devices such as mobile stations/cellular telephones, extend their limited battery power by alternating between a power saving mode or state and a full power mode or state. Various different communication standards term these differently; idle versus active states, sleep or doze versus awake states, power save versus full power states, and the like. The differing terminology refers to the same underlying concept of relative power consumption; in one of the states the device (for example, a certain subset of components powered on while others are off or at reduced power or at reduced functionality) remains powered on but the device overall draws less power from the limited power source than the other state which has more operational functionality (for example, more components at full power/functionality) powered up and ready for immediate use. In some wireless protocols there are instants within the lower power state in which the device momentarily listens for a page, and either continues to doze or wakes depending on whether it received a page. Therefore the higher power state implies the device is ready at any instant while in that state to wirelessly transmit and/or receive (for example, data, including voice packets), while the lower power state implies the device is not always ready while in that state to wirelessly transmit and/or receive. The sleep/awake divide is therefore specific to a particular radio or communication standard which governs operation of a particular radio type (for example, WLAN, GSM, UTRAN, LTE, WCDMA, Bluetooth). For example, a particular mobile device may have a primary radio (for example, cellular) and a secondary radio (for example, WLAN, Bluetooth, global positioning system), and there are different sleep/wake criteria for each so that the device may be in a sleep state respecting one of its radios while simultaneously in a wake state for another of its radios (and vice versa).

Different radio technologies implement the low power states differently. In some cellular systems a network entity signals to the mobile device which of several predetermined intervals it is assigned, during which interval the mobile device sleeps followed by a short ‘awake’ window in which the device actively listens for a page or other indication that the network is waiting to send data to it or seeks to connect it with a voice call. Other systems such as WLAN use a less signaling intensive approach, in which the mobile device (termed a station or STA in WLAN) uses its knowledge of the channel state prior to entering the sleep/doze mode to set its backoff counter value which gives the interval for its sleep mode. The backoff enables random channel access for the WLAN. Each device calculates backoff and when the backoff equals to zero, they may transmit any available buffered frames. For the next backoff operation, the backoff counter may be set to a randomly selected backoff counter value.

### SUMMARY

In a first aspect thereof the exemplary embodiments of this invention provide a method comprising: determining at an apparatus a wireless traffic load; generating at the apparatus at least one timer value based at least in part on the determined wireless traffic load, in which the at least one timer value indicates a time for initiating a transmission after changing from a lower power state to a higher power state; and initiating a wireless transmission from the apparatus at a time based at least in part on the at least one timer value.

In a second aspect thereof the exemplary embodiments of this invention provide a computer readable memory storing a program of computer instructions that when executed by at least one digital processor result in actions comprising: determining a wireless traffic load; generating at least one timer value based at least in part on the determined wireless traffic load, in which the at least one timer value indicates a time for initiating a transmission after changing from a lower power state to a higher power state; and initiating a wireless transmission at a time based at least in part on the at least one timer value.

In a third aspect thereof the exemplary embodiments of this invention provide an apparatus comprising at least one processor that is configured to determine a wireless traffic load, and configured to generate at least one timer value based at least in part on the determined traffic load. The at least one timer value indicates a time for initiating a transmission after the apparatus changes from a lower power state to a higher power state. The at least one processor is configured further to initiate a wireless transmission at a time based at least in part on the at least one timer value.

In a fourth aspect thereof the exemplary embodiments of this invention provide an apparatus comprising at least one processor and at least one memory that includes computer program code. The at least one memory including the computer program code is configured, with the at least one processor, to determine a wireless traffic load, and configured to generate at least one timer value based at least in part on the determined traffic load. The at least one timer value indicates a time for initiating a transmission after the apparatus changes from a lower power state to a higher power state. The at least one memory including the computer program code is configured, with the at least one processor to further initiate a wireless transmission at a time based at least in part on the at least one timer value.

In a fifth aspect thereof the exemplary embodiments of this invention provide an apparatus comprising processing means (such as for example one or more processors) and sending means (such as for example a transmitter). The processing means is for determining a wireless traffic load, and for generating at least one timer value based at least in part on the determined wireless traffic load. The at least one timer value indicates a time for initiating a transmission after the apparatus changes from a lower power state to a higher power state. The sending means is for initiating a wireless transmission at a time based at least in part on the at least one timer value.

These and other aspects of the invention are detailed further below.

### BRIEF DESCRIPTION OF THE DRAWINGS

FIGS. 1A-C illustrate various example environments in which various exemplary embodiments of the invention might be used, in which a transmission from a particular terminal after awakening corrupts a transmission from an already awake terminal.

FIG. 2A is a conventional timing for transitioning from a doze state to an awake state.

FIGS. 2B-2C illustrate timing for transitioning from a doze state to an awake state under different traffic conditions, according to exemplary embodiments of the invention.

FIGS. 2D-2E are similar to FIGS. 2B-C but illustrating for the case in which there is a mesh coordinated channel access opportunity with enhanced distributed channel access parameters.

FIGS. 2F-2G are similar to FIGS. 2B-C but illustrating for the case in which there is a scheduled automatic power save delivery.

FIG. 3A illustrates exemplary devices in which exemplary embodiments of the invention might be disposed.

FIG. 3B shows a more particularized block diagram of a user equipment such as that shown at FIG. 3A.

FIG. 4 is a logic flow diagram that illustrates the operation of a method, and a result of execution of computer program instructions embodied on a computer readable memory, in accordance with an exemplary embodiment of this invention.

### DETAILED DESCRIPTION

It is stipulated that while the exemplary examples and explanations herein are given in the context of a specific WLAN implementation, that is not a limiting factor and is only presented for specific examples in order to explain a practical implementation in a manner clearest to the reader. Embodiments of these teachings are readily extended to any wireless communication system in which the portable/mobile devices switch between a lower power state and a higher power state.

The WLAN power save is becoming widely deployed and is one building block for the future radio systems. A technical effect of certain embodiments of the invention is improved interoperability between channel access principle (for example, WLAN channel access principle like EDCA), and the power save mechanisms of the devices. Certain WLAN-specific embodiments of the invention are compatible with legacy 802.11 power save, U-AP SD, 802.11z, Wi-Fi peer-to-peer and 802.11s power save mechanisms.

As an overview, exemplary embodiments of this invention provide a period of time in which the STA listens for media activity. This period of time is a function of continuous load measurements that are used by the power saving WLAN STA or mesh STA after transition from the doze state to the awake state, before that STA may send its initial frame after waking from the doze state (for example, the trigger or PS-Poll frame or any MPDU frame in certain WLAN embodiments).

Before detailing these exemplary embodiments of the invention, now are detailed some specifics of the WLAN doze and awake states, and data exchange between the STA and the access point (AP), which are relevant to the exemplary embodiments of this invention. As a matter of convention, traffic originating at a STA and bound for its AP is uplink traffic, and traffic from the AP and bound for a STA is downlink traffic. Data traffic may be communicated via infrared or other electromagnetic waves over a wireless link between AP and STA.

The AP does not transmit traffic to the STA while the STA is in the power saving/doze state, but instead queues traffic addressed to that STA until the AP receives an indication from the STA that it will be ready to receive data. The AP need not wait for such an indication when the STA is already in the awake state and may transmit any received traffic immediately.

The STA notifies the AP of the STA's transitions from the awake to doze state. The STA transmits an indication to the AP that it has changed from an awake state to a doze state to keep the AP informed so the AP may either queue or schedule transmission of traffic it receives that is destined for the STA.

One such indication the STA sends to the AP to inform it that the STA has moved from a doze state to an awake state is termed in WLAN a trigger frame, which the STA sends when it indicates that it is available to receive buffered traffic and may use an unscheduled automatic power save mechanism (U-APSD). When a legacy 802.11 power save mechanism is in use, the STA indicates to the AP that it has moved from the doze to the awake state by sending a power save poll frame. U-APSD may be considered for data comprising voice and/or streaming audio/video applications, since its unscheduled nature tends to match better with the periodic traffic characteristics typical of those types of data.

If the STA sent its power save poll frame, the AP acknowledges the STA's poll, sends a data frame which the STA acknowledges, and then the AP waits for the STA to send another poll frame to indicate it's ready to receive another data frame from the AP. Each data frame may indicate to the STA whether there are further queued data frames waiting at the AP for transmission, and the last data frame indicates that there are no further data for the STA. If instead the STA is using the U-APSD and sent its trigger frame, the AP acknowledges the STA's trigger frame and transmit at least one frame to the STA. The AP indicates that it will not transmit more frames with a frame that has an end of service period (“EOSP”) bit set. After acknowledging the last data frame in U-APSD, the STA may again enter the doze state. That last acknowledgement may inform the AP that STA is not expecting to receive any more frames from the AP.

The above example relates to a hierarchical network environment in which the STA communicates with an AP. In another embodiment for a mesh network a local mesh STA notifies the peer mesh STA of the local mesh STA's transitions between the awake and doze states. The local mesh STA transmits an indication to the peer mesh STA that it has changed between an awake state and a doze state to keep the peer mesh STA informed so the peer mesh STA may either queue or schedule transmission of traffic it receives that is destined for the local mesh STA.

An indication that the local mesh STA sends to the peer mesh STA to inform that the local mesh STA has moved from a doze state to an awake state is termed for example in WLAN as a peer trigger frame. The local mesh STA indicates that it is available to receive buffered traffic.

When the power saving mesh STA has setup a mesh coordinated channel access (MCCA) opportunity, the peer mesh STA may transmit frames to the local mesh STA in a power save mode only after the negotiated initiation time of the MCCA opportunity. The transmitter mesh STA in the MCCA opportunity knows the time after which the receiving mesh STA operates in the awake state. The transmitter STA in the MCCA opportunity may transmit frames after that time.

In another embodiment the power save may be applied also in a tunneled direct link between two STAs (local or peer) that are associated with the same AP. The STAs are using the AP as a broker and AP forwards setup messages between devices to establish direct link between the devices.

The local or peer STA in the direct link may switch to the power save mode and operate in a peer U-APSD mode. In the peer U-APSD the peer STA operates in the awake state similarly as the AP in the U-APSD, and the local STA may operate in the power save state like doze. The local STA notifies the peer STA of the local STA's transitions between the awake and doze states. The local STA transmits an indication to the peer STA that it has changed between an awake state and a doze state to keep the peer STA informed so the peer STA may either queue or schedule transmission of traffic it receives that is destined for the local STA.

The peer STAs in the direct link may setup a peer power save mode (PSM). In the peer PSM the STAs in the direct link may transmit a trigger frame to each other during the negotiated peer awake window.

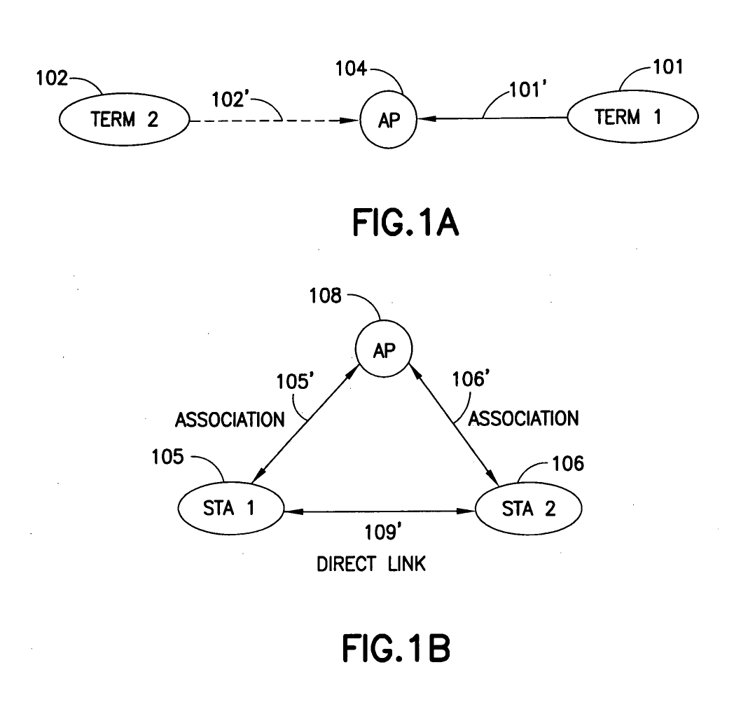

FIG. 1A illustrates a first example environment in which an exemplary embodiment of the invention might be used, in which a transmission from terminal 2 after awakening corrupts a transmission from terminal 1. There are two terminals 101, 102 at FIG. 1A with wireless links 101′, 102′ to the same AP 104. Terminal 1 is in the awake state and actively communicating. Terminal 2 102 is in U-APSD, and when it awakes it sends its trigger frame on link 102′ to the AP 104. Since the terminal 2 was in a power save like doze state immediately prior to sending this trigger frame, there is no control over preventing its collision with data or acknowledgements (or polls) being communicated between that same AP 104 and the other terminal 1 on another wireless link 101′. Before entering the power save state the Terminal 2 102 was in the awake state and so had accurate knowledge of the current channel state in order to calculate its backoff operation. However, as the terminal 2 wakes-up from power save, it is unaware of the ongoing transmissions and so its backoff value has likely re-calculated to zero, meaning it may send traffic immediately after the AIFS (assuming the channel is idle).

A similar effect could arise if either or both of terminal 1 and 2 were engaging in direct communications with other communication nodes rather than with a common AP 104, as shown at FIG. 1B. FIG. 1B illustrates a basic peer mesh arrangement, in which the two STAs 105, 106 are in association with the same AP 108 via links 105′, 106′. There is a direct link 109′ between those two peer STAs, which is setup using messages forwarded by the AP 108.

At FIG. 1C there are a plurality of mesh stations (MSTA) (112, 114, 116 and 118) with peerings (113, 115, 117 and 119) between MSTA pairs. There may also be a portal 110 with a peer or other link 111, 112 to one or more of the MSTAs 112, 114, typically connecting the mesh network to either another mesh network and/or to a broader network such as Ethernet or the Internet. When one of the STAs or MSTAs awakens from a doze state and transmits, there is the potential that this transmission will collide with other transmissions ongoing in the network.

There are two primary differences between FIGS. 1B and 1C. First, mesh communications are not limited to direct links but may occur between MSTAs that have no direct peer link between them, such as where one or more intervening MSTAs act as relay node(s) for the peer communications. Second, setup of the peer links 113, 115, 117 and 119 may be done directly between the linked MSTAs or may be done by another MSTA having peer links already established with the other two MSTAs (for example, MSTA 114 may use established links 113 and 119 to relay setup messages by which MSTAs 112 and 118 establish the direct peer link 115). In the description below, the term STA includes MSTAs operating in a mesh network.

Exemplary embodiments of this invention specify an extra media listening time period as a function of continuous load measurements that is used by the power saving STA or MSTA after transition from the doze to the awake state before it sends the trigger frame. This load measurement is not used to measure rate of a media stream between the affected STA and the AP, it is an estimate of the total load in the network which is different from any traffic rate between any individual STA and the AP (or other individual mesh STA). From this load measurement or estimate of the total traffic load, collisions may be avoided or statistically minimized as will be shown below. Also detailed below for both WLAN mesh and infrastructure (hierarchical) networks are exemplary but non-limiting techniques for measuring such a network load.

Specific to exemplary WLAN embodiments of the invention, this extra media listening period enables the STA to have a better opportunity to update its network allocation vector (NAV) according to current ongoing transmissions and avoid possible data transmission collisions. In an exemplary embodiment, the STA may utilize continuous load measurements and computes extra media listening time separately per beacon interval (the time between consecutive beacons from the same AP). The STA may detect ongoing transmissions in the network during this extra media listening time, and set its NAV to protect the ongoing transmission opportunities TXOPs. Without this extra listening time, then as detailed in the examples above with respect to FIGS. 1A-C there may be no control for preventing or reducing collisions between one terminal's transmitted indication that it is waking from a doze state (for example, the STA's trigger frame or power save poll or peer trigger frame) and transmissions to or from other STA's in the network.

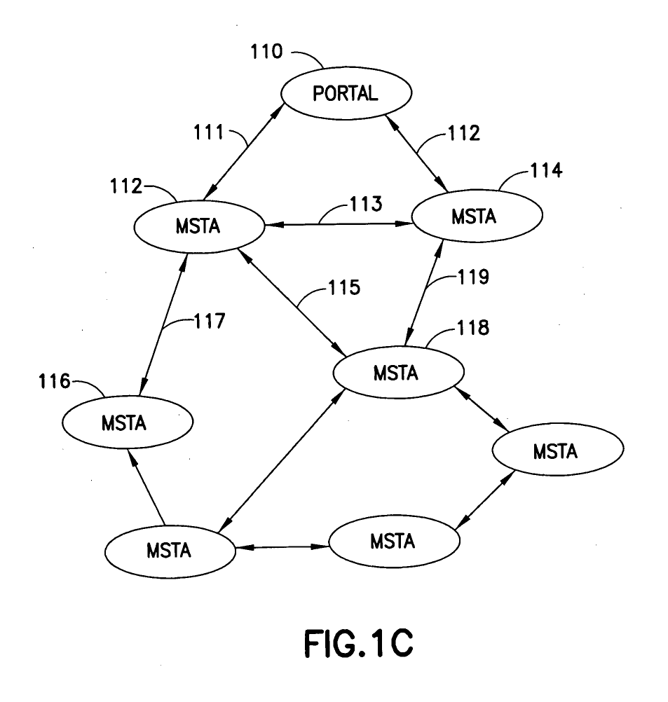

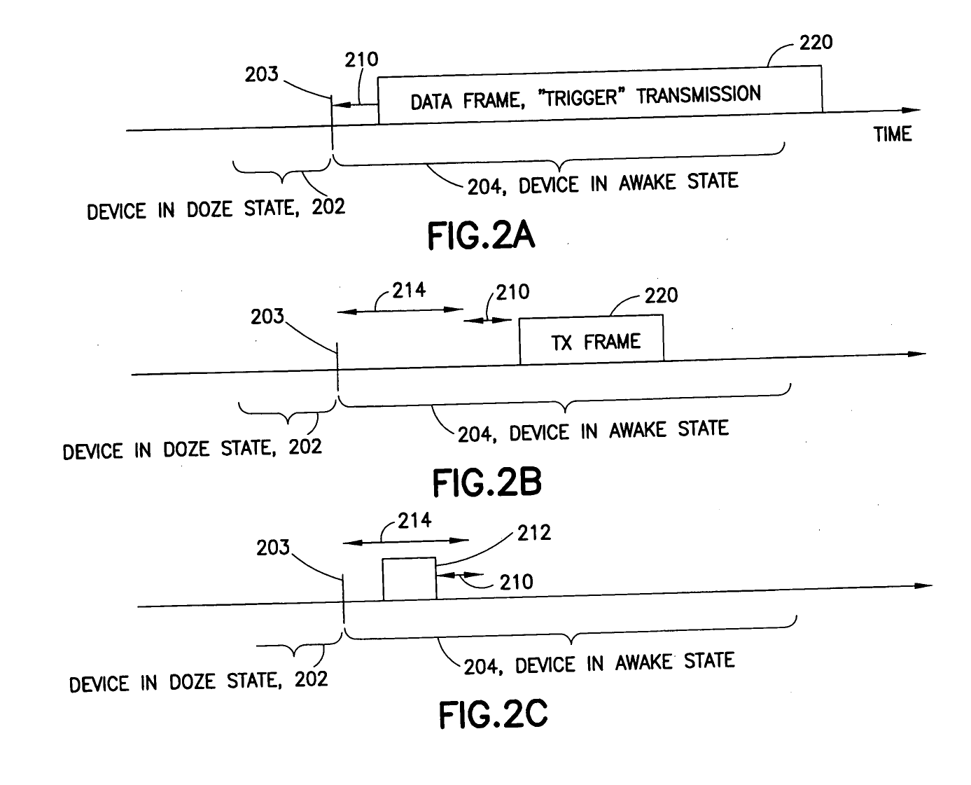

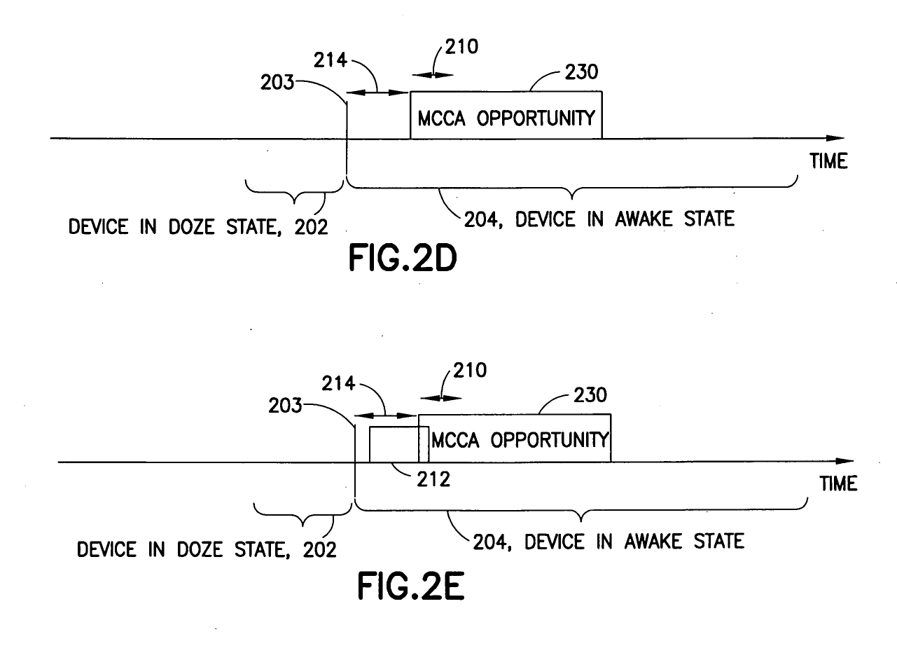

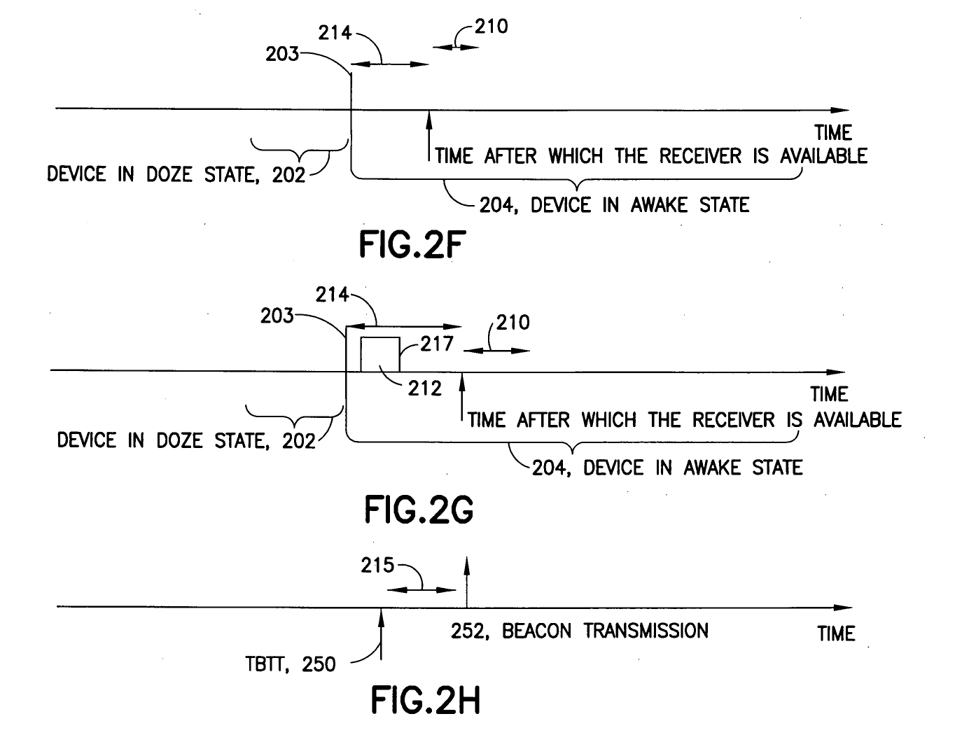

FIG. 2A is a conventional timing diagram, and FIGS. 2B to 2C are exemplary timing diagrams according to these teachings and illustrating different scenarios of network traffic load. In an embodiment of the invention the length of this extra media listening time, which may be implemented simply by at least one timer within the STA, is based at least on part on the measured or monitored or estimated traffic load. Therefore, FIGS. 2A to 2C illustrate different timing diagrams for one specific STA embodying the invention and operating in the three different network traffic load conditions reflected in those drawings, though different variations for implementing the at least one timer for the extra listening period are discussed among FIGS. 2A-C.

FIG. 2A illustrates for context a conventional timing diagram. Exemplary embodiments of this invention may revert to the FIG. 2A approach under conditions of idle or light network loading, in which the measured/estimated idle or light network load results in the additional media listening time being set to zero. The apparatus or device, which if operating in a WLAN network is a STA or one or more components thereof, is in a doze state 202 initially, and is in an awake state 204 after a transition point 203. There is a time period 210 during which the device obtains its next transmission opportunity (TXOP) that may be in the WLAN example at minimum the WLAN arbitration interframe space (AIFS). Once this time period 210 expires, the device then may transmit its trigger frame 220 (or peer trigger frame or power save poll) or data frame or other frame (different wireless systems will have different ‘first’ transmissions from the device after the doze/awake transition 203). The extra timer at FIG. 2A is set to zero in an embodiment of these teachings (and so is not particularly shown at FIG. 2A), because the network traffic measurement taken by the device found that the network was idle or light and so no additional time period was required to statistically assure that the transmission of the trigger frame 220 would not collide with other traffic in the network. At FIG. 2A the device transitioning 203 from a power saving/doze state 202 to the awake state 204 does not apply extra listening time and the timer is set to zero based on the idle/light traffic condition. Note that in FIG. 2A the time 210 for TXOP obtaining/AIFS is independent of traffic conditions, unless the illustrated time 210 is combined with the described traffic monitoring timer in which there is dependency on traffic in theory, but in the case of FIG. 2A since the additional media listening time is zero the actual timer value is unchanged from the legacy time 210 needed for TXOP obtaining which is typically AIFS.

FIGS. 2B-C illustrate an exemplary timing diagram for the case in which the network traffic load is moderate or high, so the network may be seen as a congested network. FIGS. 2B-C distinguish from one another in that the apparatus updates its NAV at FIG. 2C but does not at FIG. 2B; otherwise the timing considerations are similar. The doze state 202, awake state 204, transition 203 and trigger frame 220 (or power save poll or peer trigger frame) are as described for FIG. 2A, but now the time 210 for TXOP obtaining (which at minimum in an idle/lightly loaded network is the AIFS) between the transition 203 and sending of the trigger frame 220 is extended by the extra media listening time 214 illustrated there. This extra media listening time 214 may be fixed, such as for example the time associated with the highest load threshold of the lookup table noted above or a maximum output value from the algorithm noted above. Alternatively, the extra timer value which defines the extra media listening time 214 may be a function of the load (for example, there may be several timer values 214 associated with different load levels of a congested network), or a function of the number of nodes in the network or in the neighborhood (in this case, number of awake/active nodes since the STA would not be able to know of dozing nodes without additional signaling).

In the exemplary embodiment of FIG. 2C, if the apparatus received a WLAN PPDU while it was monitoring the network load during the extra media listening time 214, the device sets the backoff counter value/timer and starts the backoff calculation 210. The received PPDU likely contains a duration field that carries a value for the NAV. Thus the terminal is able to detect the ongoing transmission and avoid transmissions that collide with ongoing transmissions. The extra media listening time 214 is a maximum time during which the apparatus waits to detect an ongoing transmission (for example, to receive a PPDU). If the PPDU is received within that extra media listening time 214, the STA obtains duration for its network allocation vector (NAV) from the received PPDU, sets the backoff value/timer and transmits its frame 220 according to the normal TXOP process. Note that once the STA receives a PPDU within the extra media listening time 214, it need not wait for any remainder of that same extra media listening time 214 before starting the backoff calculation 210; the extra media listening time 214 is a maximum. The received PPDU contains duration information to set network allocation vector (NAV) protected time 212 illustrated at FIG. 2C. The backoff calculation 210 begins immediately after as shown at FIG. 2C, even if the extra media listening time 214 is not yet expired. The frame 220 is not illustrated at FIG. 2C so the timers may be clearly shown, but the frame is sent after the backoff time 210. In an exemplary embodiment dedicated backoff periods may be calculated for each or for different groups of access categories. There may be a timer value for extra media listening time and a timer value for the backoff period, where each timer value is dependent on the network traffic conditions. In an exemplary embodiment the backoff period is a function of traffic load and a random selection (for example, backoff period=random selection of some backoff time plus an adjustment due to traffic load).

If the apparatus/STA does not receive a WLAN PPDU during the extra time 214, it may obtain its TXOP within the AIFS. This is shown at FIG. 2B. There is no update to the NAV since no PPDU is received during the extra media listening time 214, so after that maximum media listening time 214 expires then the STA starts to obtain TXOP 210 and then sends its frame 220. Thus, the extra media listening time 214 protects the ongoing transmissions, but does not hinder the most efficient TXOP obtaining 210.

FIG. 2D-E illustrates an exemplary timing diagram for the case in which the devices have setup a MCCA opportunity. The doze state 202, awake state 204, transition 203 and are as described for FIG. 2A, but now the terminal wakes up to an extra time 214 before the MCCA opportunity 230 start time to detect the ongoing transmissions and update the NAV. The MCCA opportunity transmitter starts backoff calculation to obtain TXOP 210 with the MCCA opportunity specific EDCA parameters at the beginning of the MCCA opportunity 230. At FIG. 2D the STA has not received a PPDU to update its NAV and so the STA must wait the entire extra time 214 before the start of the TXOP 210 and MCCA opportunity 230. At FIG. 2E the STA received a PPDU where the NAV protected time 212 is indicated, updates its NAV from the received PPDU, and may begin the backoff calculation to obtain TXOP after the NAV 212 has expired and MCCA opportunity 230 has started. Note that at FIG. 2E there is a time overlap shown among the NAV 212 and the start of the MCCA transmit opportunity 230. The MCCA opportunity 230 starts at a negotiated time and the transmitter which has protected media with the NAV 212 may not know the start time of the MCCA opportunity 230, so during the MCCA opportunity 230 the transmitter is allowed to use the EDCA parameter set that is specific to that MCCA opportunity 230.

FIGS. 2F-G illustrate an exemplary timing diagram for the case in which the devices have setup scheduled automatic power save delivery (S-APSD). The doze state 202, awake state 204 and transition 203 and are as described for FIG. 2A, but now the terminal wakes up to an extra media listening time 214 before the S-APSD periodically repeating service period initiation time to detect the ongoing transmissions and update the NAV. This extra media listening time 214 may be fixed, such as for example the time associated with the highest load threshold of the lookup table noted above or a maximum output value from the algorithm noted above. Alternatively, the extra media listening timer value 214 may be a function of the load (for example, there are several timer values 214 associated with different load levels of a congested network), or a function of the number of nodes in the network (in this case, number of awake/active nodes since the STA would not be able to know of dozing nodes without additional signaling). If the STA does not receive a PPDU during the extra media listening time 214 as shown at FIG. 2F, it must wait the entire time 214 before starting the TXOP process 210. If the STA received a PPDU during the extra waiting time 214, such as during the NAV protected time 212 shown at FIG. 2G, the STA need not wait further for the extra timer 214 to expire; the STA sets its backoff counter and starts the backoff calculation at the termination 217 of the PPDU that it has received, but must wait until the transceiver (receiver at FIGS. 2F-G) is available if it is not yet available. The receiver becomes available during the ongoing service period after the service period is initiated (for example, after a specific time following when the service period is triggered). The S-APSD is setup with ADDTS signaling in which the time instant (periodically repeating) is agreed. The STA may transmit a frame at earliest after the service period for S-APSD has been initiated. If the backoff is calculated to zero, the terminal may transmit after the AIFS.

FIG. 2H illustrates an exemplary mechanism to monitor traffic load during the beacon reception. At a target beacon transmission time (TBTT) 250 the STA wakes from a doze state to the awake state. Thus the TBTT 250 is similar to the transition 203 of FIG. 2A. The waking STA has not yet informed the network or any peer device of that state change. After entering the awake state the STA monitors the network load and sets the beacon reception time 215 based at least in part on that monitored (or estimated) network load. That is to say, the beacon reception timer 215 includes the extra media listening time previously described. During that beacon reception time 215 the STA assesses network congestion and attempts to receive the beacon PPDU. FIG. 2H shows that PPDU which the waking STA receives as a beacon 252 which is sent by another STA or mesh STA. The waking mesh STA then may use the received beacon to estimate traffic load and adjust the extra media listening time for power save poll or peer trigger frame transmissions.

In an exemplary embodiment, the network load monitoring is autonomous by the STA (or other apparatus supporting or implementing the exemplary embodiments of the invention) and always ongoing. Load monitoring used for determining the duration for extra listening time according to these teachings may also be stored and used for other unrelated purposes such as link adaptation and handover coordination, with some expiration time after which the load monitoring results are deleted as being too old and so unreliable.

While not limiting, there are described three exemplary embodiments by which the device may detect the network load. Two of these are direct detections/measurements and one is an indirect detection/measurement. In a first exemplary embodiment, the device may directly detect the network load by averaging the load obtained from the basic service set load information element of multiple received beacons. This exemplary averaging method works particularly well when mesh and/or infrastructure networks are in proximity.

In a second exemplary embodiment the device directly obtains the network load by measuring the duration that media is occupied due to clear channel assessment (CCA) and network allocation vector (NAV).

In a third exemplary embodiment the device indirectly obtains the network load by observing the success of trigger frame transmissions. For example, the success of TXOP obtaining for trigger frame transmissions is compared against the success of TXOP obtaining for other frames. If the TXOP obtaining for trigger frames has poorer performance, then the network is considered to contain a higher load. The higher load information is given to the algorithm that controls the overhead in media listening which may increase the amount of extra listening time from the network load-dependent timer.

There are also mesh networks such as that shown at FIG. 1C in which there are multiple links and multiple destinations for the traffic. In one exemplary but non-limiting embodiment for a mesh network, the device listens for a beacon on any of the device to which it has established a link and collects statistics of the network load situation while it is listening for media in order to receive the beacon frame. Again the obtained traffic load estimation is applied to control the network load dependent extra overhead (the extra listening time). For example, a peer mesh STA may measure the traffic load during the time from target beacon transmission time to the reception of the beacon frame from neighboring device(s) as shown in FIG. 2H. Please note, that the waking mesh STA may have multiple peer mesh STAs from where it receives beacon frames and thus have many opportunities that may frequently repeat for extra traffic load assessments.

In another exemplary but non-limiting embodiment for a mesh network such as is shown at FIG. 1C, it may be that a local mesh STA (a first station) is transmitting data to other peer mesh STA (a second station), and data transmission to peer mesh STA (a third station) would start soon after this operation. In that case, then the local mesh STA (the first station) may decide to enter the doze state between the transmissions (in which case the extra listening time may be computed as above when changing from the doze state to the awake state) or it may decide to remain in the awake state and maintain its NAV information (i.e. combine its traffic load assessment time and doze state handling) in which case the extra media listening time for transmissions from the first to the third station includes all the time the first station was transmitting to the second station since the most recent doze state was prior to those transmissions.

The timing diagrams of FIGS. 2B-2G imply that the time at which the trigger frame (or other ‘first’ transmission from the waking STA) is transmitted is moved later. This need not always be the case. A similar result may be achieved by moving the transition time 203 between doze and awake states earlier, for example if the device knows the next time when it will transmit frames. In this case the device may choose to wake-up earlier than the frames generation time, in order to minimize or eliminate delays of the transmitted data. The next transmission time may be known, for example if the application generates traffic periodically (for example, voice over Internet protocol VoIP or if an audio/video streaming application is used), or if a power save mode according to IEEE 802.11s is used the next awake window or next mesh coordinated channel access (MCCA) period of the receiver may be known.

Certain of the above exemplary embodiments provide the technical effect of improving system capacity by reducing the number of data transmission collisions. Another technical effect of certain embodiments is that the reduced collisions provide a higher data throughput, reduced transmission delays and better predictability of service quality. Still a further technical effect of certain embodiments is the (potential) re-use of the continuous load measurements for one or more other key mechanisms such as link adaptation, new peering establishment/pruning coordination and handover coordination. Additionally the network load measurements add very little complexity to the device and so are relatively easy to implement with legacy equipment.

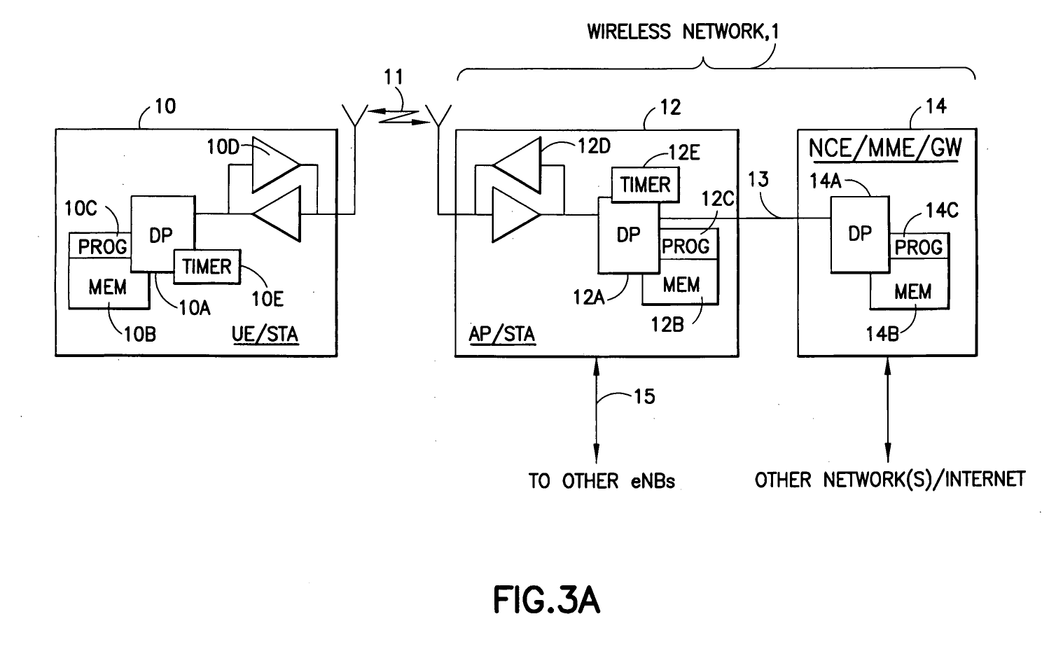

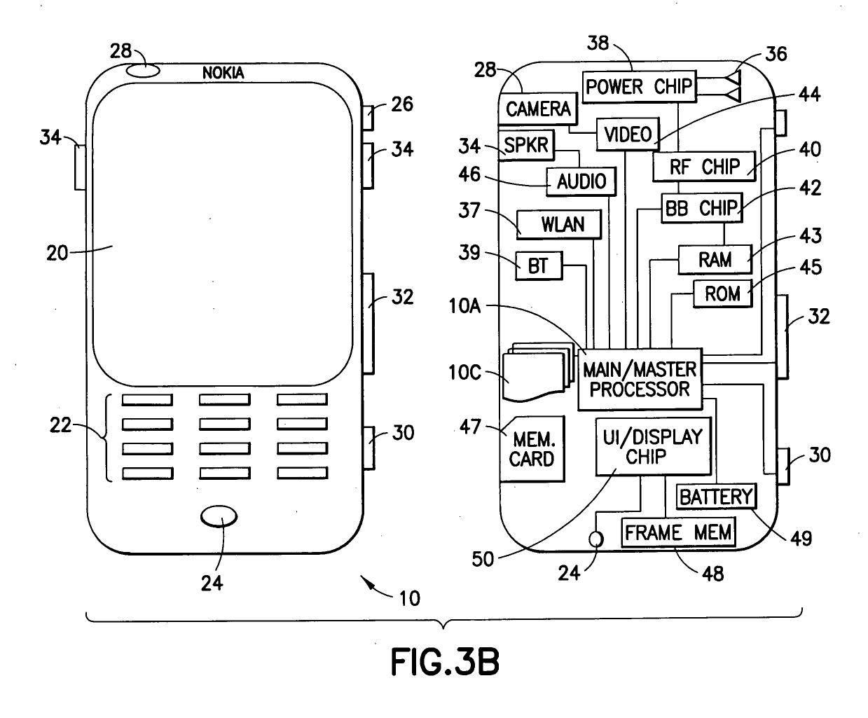

Reference is made to FIG. 3A for illustrating a simplified block diagram of various electronic devices and apparatus that are suitable for use in practicing the exemplary embodiments of this invention. In FIG. 3A a wireless network is adapted for communication over a wireless link 11 with an apparatus, such as a mobile communication device which may be referred to as a STA or a user equipment UE 10, via a network access node, such as an access point AP of a WLAN system, a base station (for example, Node B or eNB) of an infrastructure/cellular network, or a mesh STA of a mesh WLAN network as non-limiting examples. If the access point is a base station of an infrastructure network, there may be a network control element (NCE) 14 which provides connectivity with other networks such as a telephone network and/or a data communications network (for example, the internet). Or if the access node is an AP 12 the AP may provide direct connectivity with other networks.

The UE 10 includes a controller, such as a computer or a data processor (DP) 10A, a computer-readable memory medium embodied as a memory (MEM) 10B that stores a program of computer instructions (PROG) 10C, and a suitable radio frequency (RF) transceiver 10D for bidirectional wireless communications with the access node 12 via one or more antennas. The access node 12 also includes a controller, such as a computer or a data processor (DP) 12A, a computer-readable memory medium embodied as a memory (MEM) 12B that stores a program of computer instructions (PROG) 12C, and a suitable RF transceiver 12D for communication with the UE 10 via one or more antennas. The access node 12 is coupled via a data/control path 13 to the NCE 14 or to another network if present. The access node 12 if implemented as a base station may also be coupled to another base station via data/control path 15.

For the purposes of illustrating the exemplary embodiments of this invention the UE 10 may be assumed to also include a timer 10E which is dependent on the network load, and the access node 12 may also include a timer 12E. Such a timer 10E, 12E may be separate from the DP 10A, 12E or integrated thereon.

At least one of the PROGs 10C and 12C is assumed to include program instructions that, when executed by the associated DP, enable the device to operate in accordance with the exemplary embodiments of this invention, as was detailed more particularly above. Certain exemplary embodiments of this invention may be implemented at least in part by computer software executable by the DP 10A of the UE 10 and/or by the DP 12A of the access node 12, or by hardware, or by a combination of software and hardware (and firmware).

In general, the various embodiments of the UE 10 may include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The computer readable MEMs 10B and 12B may be of any type suitable to the local technical environment and may be implemented using any suitable data storage technology, such as semiconductor based memory devices, flash memory, magnetic memory devices and systems, optical memory devices and systems, fixed memory and removable memory. The DPs 10A and 12A may be of any type suitable to the local technical environment, and may include one or more of general purpose computers, special purpose computers, microprocessors, digital signal processors (DSPs) and processors based on a multicore processor architecture, as non-limiting examples.

FIG. 3B illustrates further detail of an exemplary UE in both plan view (left) and sectional view (right), and the invention may be embodied in one or some combination of those more function-specific components. At FIG. 3B the UE 10 has a graphical display interface 20 and a user interface 22 illustrated as a keypad but understood as also encompassing touch-screen technology at the graphical display interface 20 and voice-recognition technology received at the microphone 24. A power actuator 26 controls the device being turned on and off by the user. The exemplary UE 10 may have a camera 28 controlled by a shutter actuator 30 and optionally by a zoom actuator 32 which may alternatively function as a volume adjustment for the speaker(s) 34 when the camera module 28 is not in an active mode. Also shown is an image/video processor 44 which encodes and decodes the various image frames, and a separate audio processor 46.

Within the sectional view of FIG. 3B are seen multiple transmit/receive antennas 36 that are typically used for cellular communication. The antennas 36 may be multi-band for use with other radios in the UE. The operable ground plane for the antennas 36 may span the entire space enclosed by the UE housing, or a smaller area and disposed on a printed wiring board on which for example the power chip 38 may be formed. The power chip 38 controls power amplification on the channels being transmitted and/or across the antennas that transmit simultaneously where spatial diversity is used, and amplifies the received signals. The power chip 38 outputs the amplified received signal to the radio-frequency (RF) chip 40 which demodulates and downconverts the signal for baseband processing. The baseband (BB) chip 42 detects the signal which is then converted to a bit-stream and finally decoded. Similar processing occurs in reverse for signals generated in the apparatus 10 and transmitted from it.

The graphical display interface 20 is refreshed from a frame memory 48 as controlled by a user interface chip 50 which may process signals to and from the display interface 20 and/or additionally process user inputs from the keypad 22 and elsewhere.

Certain embodiments of the UE 10 may also include one or more secondary radios such as a wireless local area network radio WLAN 37 and a Bluetooth® radio 39, which may incorporate an antenna on-chip or be coupled to an off-chip antenna. Throughout the apparatus are various memories such as random access memory RAM 43, read only memory ROM 45, and in some embodiments removable memory such as the illustrated memory card 47, on which the various programs 10C are stored. All of these components within the UE 10 are normally powered by a portable power supply such as a battery 49.

The aforesaid processors 38, 40, 42, 44, 46, 50, if embodied as separate entities in a UE 10 or access node 12, may operate in a slave relationship to the main processor 10A, 12A, which may then be in a master relationship to them. Certain embodiments of this invention measure the network traffic load according to the exemplary embodiments set forth above in the baseband processor 42, though it is noted that other embodiments need not be disposed there but may be disposed across various chips and memories as shown or disposed within another processor that combines some of the functions described above for FIG. 3B. For example, certain other embodiments (such as certain WLAN embodiments) may use the lower medium access control logical layer (after baseband) to measure the network traffic load, and this lower MAC layer may be implemented by the main processor 10A or the RF chip 40 or by any other module (not shown in the figure (or any possible combination).

Any or all of these various processors of FIG. 3B access one or more of the various memories, which may be on-chip with the processor or separate therefrom. Note that the various chips (for example, 38, 40, 42, etc.) that were described above may be combined into a fewer number than described and, in a most compact case, may all be embodied physically within a single chip.

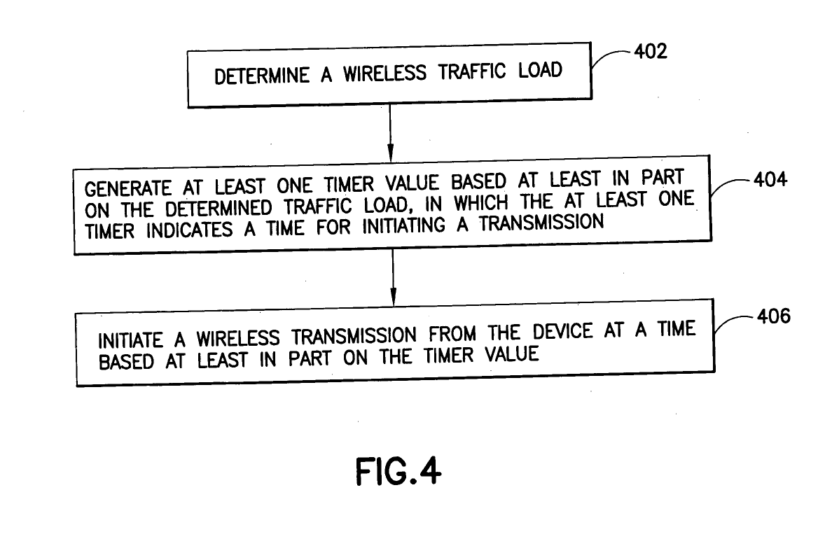

FIG. 4 is a logic flow diagram that illustrates the operation of a method, and a result of execution of computer program instructions, in accordance with the exemplary embodiments of this invention. In accordance with these exemplary embodiments a method performs at block 402 a step of determining at an apparatus a wireless traffic load; at block 404 a step of generating at the device at least one timer value based at least in part on the determined wireless traffic load, and at block 406 initiating a wireless transmission from the device at a time based at least in part on the at least one timer value. For completeness, it is noted that in some embodiments the timer at block 404 indicates a time for initiating a transmission after changing from a lower power state to a higher power state, such as for example the extra timer 214 shown at FIGS. 2B-G. It is noted that initiating a transmission does not necessarily require sending a transmission, such as where initiating the transmission is obtaining a TXOP; the TXOP is obtained prior to any frame being sent.

In various exemplary embodiments of the invention which may be combined or separate:
the determining at block 402 comprises the device continuously monitoring the traffic load;
initiating the transmission at block 406 comprises obtaining a transmission opportunity;
initiating the wireless transmission at block 406 comprises initiating transmission of a trigger frame after exiting the lower power state (in which case the lower power state is an unscheduled automatic power save delivery mode);
determining the wireless traffic load at block 402 is independent of whether the device is in the higher power state or the lower power state;
the wireless traffic load at block 402 is determined from at least one beacon received from at least one peer device in a mesh network; and
determining the wireless traffic load at block 402 comprises at least one of:
   receiving load information from multiple received beacons and averaging,
   measuring clear channel assessment and network allocation vectors, and
measuring success of transmission opportunities for different types of frames and comparing the measured successes.

The various blocks shown in FIG. 4 may be viewed as method steps, and/or as operations that result from operation of computer program code, and/or as a plurality of coupled logic circuit elements constructed to carry out the associated function(s).

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as nonlimiting examples, hardware, software, firmware, special purpose circuits or logic, general purpose hardware or controller or other computing devices, or some combination thereof.

It should thus be appreciated that at least some aspects of the exemplary embodiments of the inventions may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

For example, while the exemplary embodiments have been described above in the context of the WLAN system, it should be appreciated that the exemplary embodiments of this invention are not limited for use with only this one particular type of wireless communication system, and that they may be used to advantage in other wireless communication systems such as for example mesh networks and hierarchical/cellular networks.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements may be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Further, the various names used for the described frames and states (for example, trigger frame, doze state, awake state, etc.) are not intended to be limiting in any respect, as these parameters may be identified by any suitable names. Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

1. A method, comprising:
determining at an apparatus a wireless traffic load;
generating at the apparatus at least one timer value based at least in part on the determined wireless traffic load, in which the at least one timer value indicates a time for initiating a transmission after changing from a lower power state to a higher power state; and
initiating a wireless transmission from the apparatus at a time based at least in part on the at least one timer value.

2. The method according to claim 1, in which the at least one timer value indicates a maximum time to listen for a physical payload data unit, and wherein the wireless transmission is initiated before expiration of the maximum time for the case where a physical payload data unit is received before the expiration.

3. The method according to claim 1, in which the at least one timer value indicates a maximum time to listen for a physical payload data unit, and wherein the wireless transmission is initiated after expiration of the maximum time for the case where no physical payload data unit is received by the expiration of the maximum time.

4. The method according to claim 1, in which determining the wireless traffic load comprises measuring traffic load of a wireless network.

5. The method according to claim 1, in which initiating the wireless transmission comprises obtaining a transmission opportunity for transmitting a trigger frame.

6. The method according to claim 1, in which initiating the wireless transmission comprises obtaining a transmission opportunity for transmitting a power save poll frame or a MPDU frame.

7. The method according to claim 1, in which determining the wireless traffic load is independent of whether the apparatus is in the higher power state or the lower power state.

8. The method according to claim 1, in which the wireless traffic load is determined by at least one of:
receiving load information from multiple received beacons and averaging;
measuring clear channel assessment and network allocation vectors; and
measuring success of transmission opportunities for different types of frames and comparing the measured successes.

9. A computer readable memory storing a program of computer instructions that when executed by a digital processor result in actions comprising:
determining a wireless traffic load;
generating at least one timer value based at least in part on the determined wireless traffic load, in which the at least one timer value indicates a time for initiating a transmission after changing from a lower power state to a higher power state; and
initiating a wireless transmission at a time based at least in part on the at least one timer value.

10. The computer readable memory according to claim 9, in which initiating the wireless transmission comprises obtaining a transmission opportunity.

11. The computer readable memory according to claim 9, in which the at least one timer value indicates a maximum time to listen for a physical payload data unit, and wherein:
the wireless transmission is initiated before expiration of the maximum time for the case where a physical payload data unit is received before the expiration; and
the wireless transmission is initiated after expiration of the maximum time for the case where no physical payload data unit is received by the expiration of the maximum time.

12. (canceled)

13. An apparatus, comprising:
at least one processor configured to determine a wireless traffic load;
the at least one processor configured to generate at least one timer value based at least in part on the determined wireless traffic load, in which the at least one timer value indicates a time for initiating a transmission after changing from a lower power state to a higher power state; and
the at least one processor configured to initiate a wireless transmission at a time based at least in part on the at least one timer value.

14. The apparatus according to claim 13, in which the at least one timer value indicates a maximum time to listen for a physical payload data unit, and wherein the wireless transmission is initiated before expiration of the maximum time for the case where a physical payload data unit is received before the expiration.

15. The apparatus according to claim 13, in which the at least one timer value indicates a maximum time to listen for a physical payload data unit, and wherein the wireless transmission is initiated after expiration of the maximum time for the case where no physical payload data unit is received by the expiration of the maximum time.

16. The apparatus according to claim 13, in which determining the wireless traffic load comprises measuring traffic load of a wireless network.

17. The apparatus according to claim 13, in which initiating the wireless transmission comprises obtaining a transmission opportunity for transmitting a trigger frame.

18. The apparatus according to claim 13, in which initiating the wireless transmission comprises obtaining a transmission opportunity for transmitting a power save poll frame or a MPDU frame.

19. The apparatus according to claim 13, in which the at least one processor is configured to determine the wireless traffic load independently of whether the apparatus is in the higher power state or the lower power state.

20. The apparatus according to claim 13, in which the at least one processor is configured to determine the wireless traffic load by at least one of:
averaging load information received from multiple received beacons;
measuring clear channel assessment and network allocation vectors; and
comparing measured successes of transmission opportunities for different types of frames.

21. An apparatus, comprising:
at least one processor and at least one memory including computer program code;
the at least one memory including the computer program code configured, with at least one processor, to cause the apparatus to:
determine a wireless traffic load;
generate at least one timer value based at least in part on the determined wireless traffic load, in which the at least one timer value indicates a time for initiating a transmission after changing from a lower power state to a higher power state; and
initiate a wireless transmission at a time based at least in part on the at least one timer value.

22. (canceled)

23. (canceled)
